(19) United States
(12) Patent Application Publication
(10) Pub. No.: US 2005/0172676 A1
(43) Pub. Date: Aug. 11, 2005

(54) Method for the production of a cylindrical quartz glass body having a low oh content

(76) Inventors: Knut Roselieb, Goettingen (DE); Sven Schmidt, Brehna (DE)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 10/512,523

(22) PCT Filed: Apr. 28, 2003
(86) PCT No.: PCT/EP03/04412

(30) Foreign Application Priority Data
Apr. 26, 2002 (DE) 102 18 864.5

(51) Int. Cl. C03B 37/018; G02B 6/18

(52) U.S. Cl. 65/421; 65/413; 65/414

(57) ABSTRACT

According to a previously known method for producing a cylindrical quartz glass body having a low OH content, first an elongate, porous soot body is produced on a rotating support by flame-hydrolyzing a silicon-containing compound and removing layers of SiO₂ particles, whereupon said soot body is subjected to a dehydration treatment and is vitrified in a vitrification furnace. The aim of the invention is to create a simple method which is based on said method and makes it possible to produce a quartz glass cylinder having a low OH content while evenly distributing the OH concentration without additional technical complexity. Said aim is achieved by subjecting the soot body to a pretreatment in protective gas and/or a vacuum in the vitrification furnace following the dehydration treatment but prior to the vitrification thereof, the soot body being heated to a temperature ranging between 100° C. and 1350° C. in a heating area.

The present invention relates to a method for producing a cylindrical quartz glass body having a low OH content in that an elongate porous soot body is first produced by flame-hydrolysis of a silicon-containing compound and by layerwise deposition of SiO₂ particles on a rotating carrier, said soot body is subjected to a dehydration treatment and is then vitrified in a vitrification furnace.

Such quartz glass bodies are e.g. used for producing preforms for optical fibers. A method of said type is described in DE 196 49 935 A1. A hollow cylindrical blank is here produced from porous quartz glass (a so-called “soot body” according to the “OVD method” (outside vapor deposition)). To this end fine SiO₂ particles are formed by flame hydrolysis of SiCl₄ and are deposited in layers on a support tube rotating about its longitudinal axis. Due to the manufacturing process the soot body contains a high content of hydroxyl groups (OH groups). These exhibit high absorption within the range of the standard working wavelengths of optical fibers and must therefore be removed. To this end the porous blank is subjected to a dehydration treatment in that it is suspended in a dehydration furnace from an embedded jig in vertical orientation and exposed to a chlorine-containing atmosphere at a high temperature. OH groups are substituted by chlorine in this process. Subsequently, the soot body treated in this way is introduced into a vitrification furnace that can be evacuated, and is vitrified in said furnace with formation of a transparent hollow cylinder of quartz glass.

During transportation of the dried soot body from the dehydration furnace into the vitrification furnace, a diffusion of H₂O is bound to occur due to the water content of the atmosphere and, as a consequence, recontamination with OH groups takes place, often accompanied by an axially and radially inhomogeneous distribution of the OH group concentration in a quartz glass cylinder obtained from the soot body after vitrification.

To avoid such a situation, it has been suggested that dehydration and vitrification of the soot body should be carried out in a joint furnace. Such a furnace, however, is complicated in its construction and can be optimized either with respect to drying or with respect to the vitrification of the soot body, but not with respect to both treatment steps. A method of this type is described in EP 0 170 249 B1 and in DE 100 05 051 A1.

Furthermore, it has been suggested that a gate through which the soot body can be transported without contact with the atmosphere from one treatment furnace to the other one should be provided between the dehydration furnace and the vitrification furnace (U.S. Pat. No. 5,032,079 and WO 93/23341). However, this suggestion for solving the problem of subsequent OH contamination requires a constructionally complicated apparatus.

U.S. Pat. No. 5,330,548 A describes a method for producing a quartz glass preform for optical fibers, wherein an SiO₂ soot body is introduced for vitrification into a furnace and is treated therein for removing gases at a temperature ranging between 900° C. and 1200° C. under reduced pressure (less than 10 Pa) and is subsequently vitrified in the same furnace at a temperature of 1550° C. This method is not suited without restriction for producing a quartz glass cylinder with a low OH content.

It is therefore the object of the present invention to indicate a simple method which without any great constructional efforts permits the production of a quartz glass cylinder with a particularly low OH content and a homogeneous distribution of the OH group concentration at the same time.

Starting from the method mentioned at the outset, said object is achieved according to the invention in that following the dehydration treatment and prior to the vitrification the soot body is subjected to a pretreatment in protective gas and/or a vacuum in the vitrification furnace, comprising a heating of the soot body in a heating zone to a temperature ranging between 100° C. and 1350° C.

In an inventive modification of the known method, the soot body is subjected, prior to vitrification, to a pretreatment in the course of which it is heated in a heating zone formed inside the vitrification furnace. An inert gas atmosphere is set in the vitrification furnace, and a negative pressure is produced and maintained therein. The efficiency of the measure is improved through an increased temperature of the soot body surface above 100° C. and below 1350° C., but dense sintering of the soot body is to be avoided. At a temperature in the range of the said upper limit a dense sintering of the soot body can be avoided by short heating periods.

The soot body is a hollow cylinder produced according to the OVD method or a solid cylinder obtained according to the known VAD method (vapor axial deposition). The temperature of the soot body is e.g. determined by means of a pyrometer, the above temperature information being based on an emission coefficient of 0.98.

It has been found that a previous recontamination of the already dried soot body can be eliminated again by way of pretreatment. OH groups which due to the porosity of the soot body migrate in front of the heating front and leave the soot body are released by heating to a temperature of at least 100° C. To prevent already purified regions of the soot body from reacting with released water again, these regions are removed by flushing with a protective gas or by evacuation. The protective gas is a noble gas substantially free from OH, or an inert gas (nitrogen). Said measures can be taken within the vitrification furnace, so that a complicated conversion of an existing vitrification furnace or valves or gates as known from the prior art can be avoided.

This permits an inexpensive production of a quartz glass cylinder with a low OH content up to and into the ppb range (wt ppb). Moreover, this procedure yields a surprisingly homogeneous distribution of the remaining OH content, i.e. viewed both over the length of the quartz glass cylinder (axial distribution) and thickness (radial distribution).

The refractive index of quartz glass is slightly increased by chlorine. Special attention must be paid to this effect of chlorine when quartz glass is produced from chlorine-containing starting materials, such as SiCl₄, and when porous “soot body” is treated in the chlorine-containing atmosphere. The dehydration treatment of the soot body is normally carried out in a halogen-containing atmosphere, particularly a chlorine-containing atmosphere. This leads to a further advantage created by pretreatment in that the pretreatment contributes to a reduction of the halogen concentration and to a homogeneous distribution of the halogen in the soot body and thus to a reduced influence on the refractive index profile.

For heating in the heating zone the soot body is fully introduced into the heating zone and is simultaneously heated therein over its whole length. Or, and this is the preferred procedure, the soot body is supplied to the heating zone, starting with its one end, and is heated therein zonewise. Zonewise heating takes place in the case of a vertically oriented longitudinal axis, starting from below or from above, in the heating zone formed inside the vitrification zone. Zonewise heating of the soot body facilitates the escape of the OH groups which due to the porosity of the soot body can migrate in front of the heating front or can leave the soot body in the direction of the longitudinal axis and, in a hollow cylindrical soot body, in the direction of the inner bore.

It has turned out to be particularly advantageous that the soot body in the heating zone is heated to a temperature ranging from 800° C. to 1180° C. during pretreatment. A temperature above 800° C. leads to an accelerated release of OH groups from the soot body, and zonewise heating shows a particularly advantageous effect for the reasons given above.

Preferably, an internal pressure of less than 100 mbar, preferably an internal pressure of less than 1 mbar, is maintained during pretreatment. The release of OH groups from the soot body is accelerated by a low pressure in the vitrification furnace. The internal pressure is therefore set to be as low as possible; a high vacuum with an internal pressure of less than 0.1 mbar is also suited. The low internal pressure is maintained at least for part of the pretreatment duration, preferably for the whole duration.

In a method in which the soot body is supplied to the heating zone, starting with one end, and is heated therein zonewise, it has turned out to be advantageous when the soot body is supplied to the heating zone at a speed of not more than 20 mm/min during pretreatment. The slower the supply speed is set, the slower is the pace at which the heating front proceeds. A slow supply speed increases the reaction time and therefore promotes the removal of OH groups from the soot body, especially in soot bodies having a large wall thickness. Dense sintering has to be avoided, which at a particularly slow supply speed may necessitate a reduction of the surface temperature of the soot body. The said lower limit of the supply speed is obtained for economic reasons.

Moreover, this procedure contributes to a homogeneous distribution of gaseous substances in the soot body, particularly chlorine.

In a particularly preferred variant, the soot body is vitrified, directly following pretreatment, at a temperature of at least 1200° C., the internal pressure prevailing at the end of the pretreatment being maintained or reduced. The pretreatment and the subsequent vitrification of the soot body are carried out in the same vitrification furnace. An increase in pressure within the vitrification furnace upon completion of the pretreatment is avoided so that an efficient removal of gaseous substances from the soot body is accomplished and the formation of gas-filled pores is avoided.

Preferably, beginning with its upper end, the soot body is supplied to the heating zone during vitrification and is vitrified therein zonewise, the supply of the soot body to the heating zone taking place in a direction opposite to that during pretreatment. This modification of the method of the invention effects an optimization of the sequence of motions and thus a reduction of the process duration and a higher throughput, and improved homogeneity is accomplished, specifically with respect to the hydroxyl group distribution in the vitrified soot body.

The cylindrical quartz glass body produced according to the method of the invention is preferably used for producing a preform for optical fibers.

The invention shall now be explained in more detail with reference to an embodiment:

### EXAMPLE 1

SiO₂ soot particles are formed by flame hydrolysis of SiCl₄ in the burner flame of a deposition burner and said particles are layerwise deposited on a support rod rotating about its longitudinal axis with formation of a soot body of porous SiO₂. After completion of the deposition method the support rod is removed. With the help of the method explained by way of example hereinafter, a transparent quartz glass tube is produced from the soot tube obtained in this way, which has a density of about 25% of the density of quartz glass:

The soot tube is subjected to a dehydration treatment for removing hydroxyl groups introduced due to the manufacturing process. To this end the soot tube is introduced in vertical orientation into a dehydration furnace and is first treated at a temperature around 900° C. in a chlorine-containing atmosphere. The treatment lasts for about eight hours. The concentration of hydroxyl groups in the soot tube is thus less than 100 wt ppb.

Subsequently, the soot tube pretreated in this way is introduced into a vitrification furnace having a vertically oriented longitudinal axis and is exposed to the open atmosphere—though for a short period of time only. The soot tube is thereby contaminated again with hydroxyl groups. To eliminate said hydroxyl groups, the soot tube is subjected to a pretreatment inside the vitrification furnace.

The vitrification furnace can be evacuated and is equipped with a ring-like graphite heating element. First of all, the furnace is flushed with nitrogen, the internal pressure of the furnace is then reduced to 0.1 mbar and heating is subsequently carried out. Starting with the lower end, the soot tube is continuously supplied from the top to the bottom to the heating element at a supply speed of 10 mm/min. At a temperature of the heating element of 1200° C., a maximum temperature of about 1180° C. is obtained on the surface of the soot body. The internal pressure inside the vitrification furnace is held by continuous evacuation at 0.1 mbar.

A release of OH groups is achieved by this zonewise vacuum and temperature treatment of the soot tube inside the vitrification furnace and a low OH group content is thus set in the soot tube prior to subsequent vitrification. The hydroxyl group concentration in the soot tube of less than 100 wt ppb, as existed after dehydration treatment, is thereby substantially reestablished. This is checked in the vitrified tube, as shall now be explained in the following.

Dehydration in chlorine-containing atmosphere may effect an incorporation of chlorine into the soot tube and a deviation of the radial refractive index profile from the desired profile and impairment of subsequent treatment steps. These effects are also reduced by the described pretreatment in that the chlorine content of the soot tube is reduced and distributed more homogeneously over the tube wall.

Vitrification is carried out directly following the above-described pretreatment in the same vitrification furnace in that the soot tube is now continuously supplied from the bottom to the top in inverse direction, i.e. starting with the upper end, to the heating element at a supply speed of 10 mm/min and is heated therein zonewise. The temperature of the heating element is preset to 1600° C., whereby a maximum temperature of about 1580° C. is obtained on the surface of the soot tube. The melt front is here migrating inside the soot tube from the outside to the inside and from the top to the bottom at the same time. The internal pressure inside the vitrification furnace is held during vitrification by continuous evacuation at 0.1 mbar.

Subsequently, the hydroxyl group content of the vitrified tube is determined. To this end a ring-like sample is taken from the upper end and from the lower end of the tube and the OH content is measured by spectroscopy at nine measuring points that are evenly distributed over the circumference of the samples (measuring distance=5 mm). Moreover, the OH content is determined by spectroscopy over the whole tube length.

A substantially homogeneous profile of the OH group concentration over the tube wall is obtained on the whole. This is applicable to both the axial distribution and the radial distribution of the OH content. In both samples a mean OH content of 0.03 wt ppm was measured, which corresponds exactly to the integrated OH content measured over the whole tube length. The radial distribution of the OH content in the quartz glass tube is also astonishingly homogeneous. A deviation of the mean value of not more than +/−0.01 wt ppm was measured on both samples.

The sintered (vitrified) tube is then elongated to an outer diameter of 46 mm and an inner diameter of 17 mm. The resulting quartz glass tube shows a particularly low hydroxyl group concentration which permits a use in the near-core area of a preform for optical fibers, e.g. as a substrate tube for internal deposition by means of MCVD methods.

### COMPARATIVE EXAMPLE 1

A soot tube having a density of about 25% of the density of quartz glass is produced by means of external deposition, as has been described above with reference to Example 1, and a transparent quartz glass tube is produced therefrom with the help of the following explained method:

The soot tube is subjected to the same dehydration treatment as has been explained above with reference to Example 1, for removing the hydroxyl groups introduced due to the manufacturing process. The concentration of hydroxyl groups in the soot tube is thus less than 100 wt ppb.

Subsequently, the soot tube pretreated in this way is introduced into a vitrification furnace with a vertically oriented longitudinal axis and is exposed to the open atmosphere—though for a short period of time. The soot tube is thereby contaminated again with hydroxyl groups. The sole difference with respect to the method described in Example 1 is that the soot tube is not subjected to pretreatment by zonewise heating inside the vitrification furnace, but is immediately vitrified after evacuation and heating of the vitrification furnace. The parameters during vitrification also correspond exactly to those explained above with reference to Example 1. This means that the soot tube is supplied from the bottom to the ring-like heating element continuously and at a supply speed of 10 mm/min and is heated therein zonewise. The temperature of the heating element is preset to 1600° C., whereby a maximum temperature of about 1580° C. is obtained on the surface of the soot tube. During vitrification the internal pressure inside the vitrification furnace is held at 0.1 mbar by continuous evacuation.

Subsequently, the hydroxyl group content of the vitrified comparative tube is determined, as has been explained above with reference to Example 1. In the comparative tube a mean OH content of 0.7 wt ppm was obtained in the sample taken from the upper end of the comparative tube and a mean OH content of 0.4 wt ppm in the sample taken from the lower end.

The axial distribution of the OH group concentration over the tube wall has thus a maximum in the area of the upper end. Moreover, distinct deviations from the above-mentioned mean value of +/−0.25 wt ppm were found in both samples in the radial distribution of the OH group concentration.

1. A method for producing a cylindrical quartz glass body having a low OH content, said method comprising: producing an elongate porous soot body by flame-hydrolysis of a silicon-containing compound and layerwise deposition of SiO₂ particles on a rotating carrier, wherein said soot body is subjected to a dehydration treatment and then vitrified in a vitrification furnace, and wherein the dehydration treatment is carried out in a dehydration furnace, and, following the dehydration treatment, the soot body is introduced into the vitrification furnace and thereby contaminated with hydroxyl groups, and, prior to the vitrification, the soot body is subjected to a pretreatment in protective gas or a vacuum in the vitrification furnace, said pretreatment comprising a heating of the soot body in a heating zone to a temperature ranging between 100° C. and 1350° C.

2. The method according to claim 1, wherein, starting at an end thereof, the soot body is supplied to the heating zone and heated therein zonewise.

3. The method according to claim 1, wherein the soot body is heated in the heating zone to a temperature ranging from 800° C. to 1180° C. during said pretreatment.

4. The method according to claim 1, wherein an internal pressure of less than 100 mbar is maintained during said pretreatment.

5. The method according to claim 3, wherein an internal pressure of less than 1 mbar is maintained during said pretreatment.

6. The method according to claim 2, wherein the soot body is supplied to the heating zone at a speed of not more than 20 mm/min during said pretreatment.

7. The method according to claim 1, wherein the soot body is vitrified at a temperature of at least 1200° C. directly following the pretreatment, the internal pressure prevailing at the end of the pretreatment being maintained or reduced.

8. The method according to claim 2, wherein said end of the soot body is an upper end, and starting with said upper end the soot body is supplied to the heating zone during vitrification and is vitrified therein zonewise, the supply of the soot body to the heating zone taking place in a direction opposite to that during said pretreatment.

9. The method according to claim 1, wherein the cylindrical quartz glass body is used for producing a preform for optical fibers.

10. The method according to claim 2 wherein the soot body is heated in the heating zone to a temperature ranging from 800° C. to 1180° C. during said pretreatment.

11. The method according to claim 10, wherein an internal pressure of less than 1 mbar is maintained during said pretreatment.

12. The method according to claim 2, wherein an internal pressure of less than 100 mbar is maintained during said pretreatment.

13. The method according to claim 3, wherein an internal pressure of less than 100 mbar is maintained during said pretreatment.

14. The method according to claim 3, wherein the soot body is supplied to the heating zone at a speed of not more than 20 mm/min during said pretreatment.

15. The method according to claim 4, wherein the soot body is supplied to the heating zone at a speed of not more than 20 mm/min during said pretreatment.

16. The method according to claim 5, wherein the soot body is supplied to the heating zone at a speed of not more than 20 mm/min during said pretreatment.

17. The method according to claim 2, wherein the soot body is vitrified at a temperature of at least 1200° C. directly following the pretreatment, the internal pressure prevailing at the end of the pretreatment being maintained or reduced.

18. The method according to claim 3, wherein the soot body is vitrified at a temperature of at least 1200° C. directly following the pretreatment, the internal pressure prevailing at the end of the pretreatment being maintained or reduced.

19. The method according to claim 4, wherein the soot body is vitrified at a temperature of at least 1200° C. directly following the pretreatment, the internal pressure prevailing at the end of the pretreatment being maintained or reduced.

20. The method according to claim 5, wherein the soot body is vitrified at a temperature of at least 1200° C. directly following the pretreatment, the internal pressure prevailing at the end of the pretreatment being maintained or reduced.

21. The method according to claim 6, wherein the soot body is vitrified at a temperature of at least 1200° C. directly following the pretreatment, the internal pressure prevailing at the end of the pretreatment being maintained or reduced.

22. The method according to claim 16, wherein the soot body is vitrified at a temperature of at least 1200° C. directly following the pretreatment, the internal pressure prevailing at the end of the pretreatment being maintained or reduced.

23. The method according to claim 22, wherein said end of the soot body is an upper end, and starting with said upper end the soot body is supplied to the heating zone during vitrification and is vitrified therein zonewise, the supply of the soot body to the heating zone taking place in a direction opposite to that during said pretreatment.
